(19) United States
(12) Patent Application Publication
(10) Pub. No.: US 2011/0167189 A1
(43) Pub. Date: Jul. 7, 2011

(54) STORAGE APPARATUS AND ITS DATA TRANSFER METHOD

(75) Inventors: Ryosuke Matsubara, Odawara (JP); Hiroki Kanai, Odawara (JP); Shogei Shimahara, Odawara (JP)

(73) Assignee: Hitachi, Ltd.

(21) Appl. No.: 12/671,159

(22) PCT Filed: Nov. 17, 2009
(86) PCT No.: PCT/JP2009/006150

§ 371 Date: Jan. 28, 2010

(30) Foreign Application Priority Data
Jul. 24, 2009 (JP) 2009-173285

(51) Int. Cl. G06F 13/28; G06F 12/00

(52) U.S. Cl. 710/308; 711/154; 711/E12.001

(57) ABSTRACT

By writing a command for transferring data from a first cluster to a second cluster and the second cluster writing data that was requested from the first cluster based on the command into the first cluster, data can be transferred in real time from the second cluster to the first cluster without having to issue a read request from the first cluster to the second cluster.

### TECHNICAL FIELD

The present invention generally relates to a storage apparatus, and in particular relates to a storage apparatus comprising a plurality of clusters as processing means for providing a data storage service to a host computer, and having improved redundancy of a data processing service to be provided to a user. The present invention additionally relates to a data transfer control method of a storage apparatus.

### BACKGROUND ART

A storage apparatus used as a computer system for providing a data storage service to a host computer is demanded of reliability in its data processing and improved responsiveness for such data processing.

Thus, with this kind of storage apparatus, proposals have been made for configuring a controller from a plurality of clusters in order to provide a data storage service to a host computer.

With this kind of storage apparatus, the data processing can be sped up since the processing based on a command received by one cluster can be executed with a processor of that cluster and a processor provided to another cluster.

Meanwhile, since a plurality of clusters exist in the storage apparatus, even if a failure occurs in one cluster, the other cluster can make up for that failure and continue the data processing. Thus, there is an advance in that the data processing function can be made redundant. A storage apparatus comprising a plurality of clusters is described, for instance, in Japanese Patent Laid-Open Publication No. 2008-134776.

### CITATION LIST

### Patent Literature

PTL 1: Japanese Patent Laid-Open Publication No. 2008-134776

### SUMMARY OF INVENTION

### Technical Problem

With this kind of storage apparatus, in order to coordinate the data processing between a plurality of clusters, it is necessary for the plurality of clusters to mutually confirm the status of the other cluster. Thus, for example, one cluster writes, at a constant frequency, the status of a micro program into the other cluster.

Moreover, if one cluster needs information concerning the status of the other cluster in real time, it directly accesses the other cluster and reads the status information.

Meanwhile, with the method of one cluster reading data from the other cluster, since the reading requires processing across a plurality of clusters, the issue source cluster of reading is not able to perform other processing until a read request is returned from the issue destination cluster of reading. Since the read processing is performed in 4-byte units, the reading of substantial statuses at once will lead to considerable performance deterioration. Consequently, it will not be possible to achieve the objective of a storage apparatus comprising a plurality of clusters for expeditiously performing data processing upon coordinating the plurality of clusters.

In addition, this problem becomes even more prominent when the plurality of clusters are connected with PCI-Express. Specifically, if a read request is issued from a first cluster to a memory of a second cluster, completion of read data is responded from the second cluster to the first cluster. When a read request is issued from the first cluster, data communication using a PCI-Express port connecting the clusters is managed with a timer.

If a completion cannot be issued within a given period of time from the second cluster in response to the read request from the first cluster, the first cluster determines this to be a completion time out to the PCI-Express port, and the first cluster or the second cluster blocks this PCI-Express port by deeming it to be in an error status.

Here, since a failure has occurred in the second cluster that is unable to issue the completion, the first cluster will need to perform the processing of the I/O from the host computer. However, since the completion time out has occurred, the management computer will mandatorily determine that the first cluster is also of a failure status as with the second cluster, and the overall system of the storage apparatus will crash.

Moreover, when writing write data to be written into the first cluster from the host computer to the first cluster to which it is connected, and redundantly writing such write data into the second cluster by transferring it from the first cluster to the second cluster, the host computer is unable to issue the write end command to the second cluster. Thus, there is a problem in that the data of the second cluster cannot be decided.

In light of the above, an object of the present invention is to provide a storage apparatus and its data transfer control method that is free from delays in cluster interaction processing and system crashes caused by integration of multiple clusters even when it is necessary to transfer data in real time between multiple clusters in a storage apparatus including multiple clusters.

Another object of the present invention is to provide a storage system capable of deciding the data of the second cluster even if the host computer is unable to issue the write end command to the second cluster.

### Solution to Problem

In order to achieve the foregoing object, with the present invention, by writing a command for transferring data from a first cluster to a second cluster and the second cluster writing data that was requested from the first cluster based on the command into the first cluster, data can be transferred in real time from the second cluster to the first cluster without having to issue a read request from the first cluster to the second cluster.

### Advantageous Effects of Invention

According to the present invention, it is possible to provide a storage apparatus and its data transfer control method that is free from delays in cluster interaction processing and system crashes caused by integration of multiple clusters even when it is necessary to transfer data in real time between multiple clusters in a storage apparatus including multiple clusters.

Moreover, according to the present invention, as a result of using a command for transferring data from the first cluster to the second cluster in substitute for the write end command of the host computer, even if the host computer is unable to issue the write end command to the second cluster, it is possible to provide a storage system capable of deciding the data of the second cluster.

### DESCRIPTION OF EMBODIMENTS

Embodiments of the present invention are now explained. FIG. 1 is a block diagram of a storage system comprising the storage apparatus according to the present invention. This storage system is realized by host computers 2A, 2B as a higher-level computer and a storage device 4 being connected to a storage apparatus 10.

The storage apparatus 10 comprises a first cluster 6A connected to the host computer 2A and a second cluster 6B connected to the host computer 2B. The two clusters are able to independently provide data storage processing to the host computer. In other words, the data storage controller is configured from the cluster 6A and the cluster 6B.

The data storage processing to the host computer 2A is provided by the cluster 6A (cluster A), and also provided by the cluster 6B (cluster B). The same applies to the host computer 2B. Therefore, the two clusters are connected with an inter-cluster connection path 12 for coordinating the data storage processing. The sending and receiving of control information and user data between the first cluster (cluster 6A) and the second cluster (cluster 6B) are conducted via the connection path 12.

As the inter-cluster connection path, a bus and communication protocol compliant with the PCI (Peripheral Component Interconnect)-Express standard capable of realizing high-speed data communication where the data traffic per one-way lane (maximum of eight lanes) is 2.5 Gbit/sec.

The cluster 6A and the cluster 6B respectively comprise the same devices. Thus, the devices provided in these clusters will be explained based on the cluster 6A, and the explanation of the cluster 6B will be omitted. While devices of the cluster 6A and devices of the cluster 6B are identified with the same Arabic numerals, they are differentiated based on the alphabet provided after such Arabic numerals. For example, “**A” shows that it is a device of the cluster 6A and “**B” shows that it is a device of the cluster 6B.

The cluster 6A comprises a microprocessor (MP) 14A for controlling its overall operation, a host controller 16A for controlling the communication with the host computer 2A, an I/O controller 18A for controlling the communication with the storage device 4, a switch circuit (PCI-Express Switch) 20A for controlling the data transfer to the host controller and the storage device and the inter-cluster connection path, a bridge circuit 22A for relaying the MP 14A to the switch circuit 20A, and a local memory 24A.

The host controller 16A comprises an interface for controlling the communication with the host computer 2A, and this interface includes a plurality of communication ports and a host communication protocol chip. The communication port is used for connecting the cluster 6A to a network and the host computer 2A, and, for instance, is allocated with a unique network address such as an IP (Internet Protocol) address or a WWN (World Wide Name).

The host communication protocol chip performs protocol control during the communication with the host computer 2A. Thus, as the host communication protocol chip, for example, if the communication protocol with the host computer 2A is a fibre channel (FC: Fibre Channel) protocol, a fibre channel conversion protocol chip is used and, if such communication protocol is an iSCSI protocol, an iSCSI protocol chip is used. Thus, a host communication protocol chip that matches the communication protocol with the host computer 2A is used.

Moreover, the host communication protocol chip is equipped with a multi microprocessor function capable of communicating with a plurality of microprocessors, and the host computer 2A is thereby able to communicate with the microprocessor 14A of the cluster 6A and the microprocessor 16B of the cluster 6B.

The local memory 24A is configured from a system memory and a cache memory. The system memory and the cache memory may be mounted on the same device as shown in FIG. 1, or the system memory and the cache memory may be mounted on separate devices.

In addition to storing control programs, the system memory is also used for temporarily storing various commands such as read commands and write commands to be provided by the host computer 2A. The microprocessor 14A sequentially processes the read commands and write commands stored in the local memory 24A in the order that they were stored in the local memory 24A.

Moreover, the system memory 24A records the status of the clusters 6A, 6B and micro programs to be executed by the MP 14A. As the status, there is the processing status of micro programs, version of micro programs, transfer list of the host controller 16A, transfer list of the I/O controller, and so on.

The MP 14A may also write, at a constant frequency, its own status of micro programs into the system memory 24B of the cluster 6B.

The cache memory is used for temporarily storing data that is sent and received between the host computer 2A and the storage device 4, and between the cluster 6A and the cluster 6B.

The switch circuit 20A is preferably configured from a PCI-Express Switch, and comprises a function of controlling the switching of the data transfer with the switch circuit 20B of the cluster 6B and the data transfer with the respective devices in the cluster 6A.

Moreover, the switch circuit 20A comprises a function of writing the write data provided by the host computer 2A in the cache memory 24A of the cluster 6A according to a command from the microprocessor 14A of the cluster 6A, and writing such write data into the cache memory 24B of the cluster 6B via the connection path 12 and the switch circuit 20B of another cluster 6B.

The bridge circuit 22A is used as a relay apparatus for connecting the microprocessor 14A of the cluster 6A to the local memory 24A of the same cluster, and to the switch circuit 20A.

The switch circuit (PCI-Express Switch) 20A comprises a plurality of PCI-Express standard ports (PCIe), and is connected, via the respective ports, to the host controller 16A and the I/O controller 18A, as well as to the PCI-Express standard port (PCIe) of the bridge circuit 22A.

The switch circuit 20A is equipped with a NTB (Non-Transparent Bridge) 26A, and the NTB 26A of the switch circuit 20A and the NTB 26B of the switch circuit 20B are connected with the connection path 12. It is thereby possible to arrange a plurality of MPs in the storage apparatus 10. A plurality of clusters (domains) can be connected by using the NTB. To put it differently, the MP 14A is able to share and access the address space of the cluster 6B (separate cluster) based on the NTB. A system that is able to connect a plurality of MPs is referred to as a multi CPU, and is different from a system using the NTB.

The storage apparatus of the present invention is able to connect a plurality of clusters (domains) by using the NTB. Specifically, the memory space of one cluster can be used; that is, the memory space can be shared among a plurality of clusters.

Meanwhile, the bridge circuit 22A comprises a DMA (Direct Memory Access) controller 28A and a RAID engine 30A. The DMA engine 28A performs the data transfer with devices of the cluster 6A and the data transfer to the cluster 6B without going through the MP 14A.

The RAID engine 30A is an LSI for executing the RAID operation to user data that is stored in the storage device 4. The bridge circuit 22A comprises a port 32A that is to be connected to the local memory 24A.

As described above, the microprocessor 14A has the function of controlling the operation of the overall cluster 6A. The microprocessor 14A performs processing such as the reading and writing of data from and into the logical volumes that are allocated to itself in advance in accordance with the write commands and read commands stored in the local memory 24A. The microprocessor 14A is also able to execute the control of the cluster 6B.

To which microprocessor 14A (14B) of the cluster 6A or the cluster 6B the writing into and reading from the logical volumes should be allocated can be dynamically changed based on the load status of the respective microprocessors or the reception of a command from the host computer designating the associated microprocessor for each logical volume.

The I/O controller 18A is an interface for controlling the communication with the storage device 4, and comprises a communication protocol chip for communicating with the storage device. As this protocol chip, for example, an FC protocol chip is used if the storage device is an FC hard disk drive, and a SAS protocol chip is used if the storage device is a SAS hard disk drive.

When applying a SATA hard disk drive, the FC protocol chip or the SAS protocol chip can be applied as the storage device communication protocol chips 22A, 22B, and the configuration may also be such that the connection to the SATA hard disk drive is made via a SATA protocol conversion chip.

The storage device is configured from a plurality of hard disk drives; specifically, FC hard disk drives, SAS hard disk drives, or SATA hard disk drives. A plurality of logical units as logical storage areas for reading and writing data are set in a storage area that is provided by the plurality of hard disk drives.

A semiconductor memory such as a flash memory or an optical disk device may be used in substitute for a hard disk drive. As the flash memory, either a first type that is inexpensive, has a relatively slow writing speed, and with a low write endurance, or a second type that is expensive, has faster write command processing that the first type, and with a higher write endurance than the first type may be used.

Although the RAID operation was explained to be executed by the RAID controller (RAID engine) 30A of the bridge circuit 22A, as an alternative method, the RAID operation may also be achieved by the MP executing software such as a RAID manager program.

FIG. 2 is a hardware block diagram of a storage apparatus explaining the second embodiment to which the present invention is applied. The second embodiment differs from the first embodiment illustrated in FIG. 1 in that the switch circuit 20A (FIG. 1) has been omitted from the storage apparatus, and the NTB port of the switch circuit is provided to the bridge circuit 22A. In this embodiment, the bridge circuit 22A concurrently functions as the switch circuit 20A. The host controller 16A and the I/O controller 18A are connected to the bridge circuit 22A via a PCI port.

FIG. 3 is a hardware block diagram of a storage apparatus according to the third embodiment. The third embodiment differs from the first embodiment illustrated in FIG. 1 in that the switch circuit 20A is configured from an ASIC (Application Specific Integrated Circuit) including a DMA controller 28A and a RAID engine 30A, in which a cache memory 24A-2 is connected thereto, and that a system memory 24A-1 is connected to the bridge circuit 22A.

While the cache memory 24A-2 is connected to the MP 14A via the bridge circuit 22A and the switch circuit 20A in FIG. 3, this is integrated with the system memory and used as the local memory 24A in FIG. 1. Thus, the embodiment illustrated in FIG. 1 is able to reduce the latency between the MP 14A and the cache memory 24A.

As shown in FIG. 3, by configuring the switch circuit 20A from ASIC, the system crash of the cluster 6A can be avoided by the switch circuit 22A sending a dummy completion to the micro programs that are being executed by the MP 14 during the completion time out. However, with the present invention, as described later, since the data transfer from the cluster 6B to the cluster 6A does not depend on a read command and is achieved with the write processing between the cluster 6A and the cluster 6B, there will be no occurrence of a completion time out, and the switch circuit 20A does not have to be configured from ASIC, and may be configured by comprising a general-purpose item (PCI Express switch).

An operational example of the storage apparatus (FIG. 1) according to the present invention is now explained with reference to FIG. 4. This operation also applies to FIG. 2 and FIG. 3.

In this storage apparatus, when the first cluster is to acquire data from the second cluster, the first cluster does not read data from the second cluster, but rather the first cluster writes a transfer command to the DMA of the second cluster, and the target data is DMA-transferred from the second cluster to the first cluster.

FIG. 4 is a block diagram explaining the exchange of control data and user data between the first cluster 6A and the second cluster 6B. The DMA controller is abbreviated as “DMA” in the following explanation.

The MP 14A of the cluster 6A or the MP 14B of the cluster 6B writes a transfer list as a data transfer command to the DMA 28B into the system memory 24B of the cluster 6B (S1). The writing of the transfer list occurs when the cluster 6A attempts to acquire the status of the cluster 6B in real time, or otherwise when a read command is issued from the host computer 2A or 2B to the storage apparatus. This transfer list includes control information that prescribes DMA-transferring data of the system memory 24B of the cluster 6B to the system memory 24A of the cluster 6A.

Subsequently, the micro program that is executed by the MP 14A starts up the DMA 28B of the cluster 6B (S2). The DMA 28B that was started up reads the transfer list set in the system memory 24B (S3).

The DMA 28B issues a write request for writing the target data from the system memory 24B of the cluster 6B into the system memory 24A of the cluster 6A according to the transfer list that was read (S4).

If the cluster 6A requires user data of the cluster 6B, the MP 14B stages the target data from the HDD 4 to the cache memory of the local memory 24B.

The DMA 28B writes “completion write” representing the completion of the DMA transfer into a prescribed area of the system memory 24A (S5).

The micro program of the cluster 6A confirms that the data migration is complete by reading the completion write of the DMA transfer completion from the cluster 6B that was written into the memory 24A (S6).

If the micro program of the cluster 6A is unable to obtain a completion write of the DMA transfer completion even after the lapse of a given period of time, the cluster 6A determines that some kind of failure occurred in the cluster 6B, and subsequently continues the processing during the anti-failure such as executing jobs of the cluster 6B on its behalf.

Consequently, the storage apparatus is able to migrate data between the clusters only with write processing. In comparison to read processing, the time that write processing binds the MP is short. While the MP that issues a read command must stop the other processing until it receives a read result, the MP that issues a write command is released at the point in time that it issues such write command.

Moreover, even if some kind of failure occurs in the cluster 6B, since a read command will not be issued from the cluster A to the cluster B, completion time out will not occur. Thus, the storage apparatus is able to avoid the system crash of the cluster 6A.

In order to substitute the reading of data of the cluster 6B by the cluster 6A with the writing of the transfer list from the cluster 6A into the DMA 28B of the cluster 6B and the DMA data transfer to the cluster 6A by the DMA 28B of the cluster 6B, the system memory 6A is set with a plurality of control tables. The same applies to the system memory 6B.

This control table is now explained with reference to FIG. 5. As shown in the system memory 24A of the cluster 6A, the control table includes a DMA descriptor table (DMA Descriptor Table) storing the transfer list, a DMA status table (DMA Status Table) storing the DMA status, a DMA completion status table (DMA Completion Status Table) storing the completion write which represents the completion of the DMA transfer, and a DMA priority table storing the priority among masters in a case where the right of use against the DMA is competing among a plurality of masters.

The DMA 28A of the cluster 6A executes the data transfer within the cluster 6A, as well as the writing of data into the cluster 6B. Accordingly, in the DMA descriptor table, a descriptor table (A-(1)) as a transfer list for transferring data within the self-cluster is included in the DMA of the self-cluster (cluster 6A), and a descriptor table (A-(2)) as a transfer list for transferring data to the other cluster 6B is included in the DMA of the self-cluster (cluster 6A). The table A-1 is written by the cluster 6A. The table A-2 is written by the cluster 6B.

The DMA status table includes a status table for the DMA 28A of the cluster 6A and a status table for the DMA 28B of the cluster 6B. The DMA 28A of the cluster 6A writes data of the cluster 6A into the cluster 6B according to the transfer list that was written by the cluster 6B, and, contrarily, the DMA 28B of the cluster 6B writes data of the cluster 6B into the cluster 6A according to the transfer list written by the cluster 6A.

In order to control the write processing between the cluster 6A and the cluster 6B, either the cluster 6A writes or the cluster 6B writes into the DMA status table of the cluster 6A or the DMA status table of the cluster 6B. The same applies to the DMA descriptor table and the DMA completion status table.

A-(3) is a status table that is written by the self-cluster (cluster 6A) and allocated to the DMA of the cluster 6A.

A-(4) is a status table that is written by the self-cluster and allocated to the DMA 28B of the cluster 6B.

A-(5) is a status table that is written by the cluster 6B and allocated to the DMA 28B of the cluster 6B, and A-(6) is a status table that is written by the cluster 6B and allocated to the DMA 28A of the cluster 6A.

The DMA status includes information concerning whether that DMA is being used in the data transfer, and information concerning whether a transfer list is currently being set in that DMA. Among the signals configured from a plurality of bits showing the DMA status, “1” (in use flag) being set as the bit [0] shows that the DMA is being used in the data transfer.

If “1” (standby flag) is set as the bit [1], this shows that a transfer list is set, currently being set, or is about to be set in the DMA. If neither flag is set, it means that the DMA is not involved in the data transfer.

The foregoing status tables mapped to the memory space of the system memory in the cluster 6A are explained in further detail below.

A-(3) bit [0]: To be used for the writing by the “in use flag” cluster 6A, and shows whether the self-cluster (cluster 6A) is using the self-cluster DMA 28A for data transfer.

A-(3) bit [1]: To be used for the writing by the “standby flag” cluster 6A, and shows whether the self-cluster is currently setting the transfer list to the self-cluster DMA 28A.

A-(4) bit [0]: To be used for the writing by the “in use flag” cluster 6A, and shows whether the self-cluster is using the cluster 6B DMA for data transfer.

A-(4) bit [1]: To be used for the writing by the “standby flag” cluster 6A, and shows whether the self-cluster is currently setting the transfer list to cluster 6B DMA.

A-(5) bit [0]: To be used for the writing by the “in use flag” cluster 6B, and shows whether the cluster 6B (separate cluster) is using the cluster 6B DMA 28B for data transfer.

A-(5) bit [1]: To be used for the writing by the “standby flag” cluster 6B, and shows whether the cluster 6B is currently setting the transfer list to DMA 28B.

A-(6) bit [0]: To be used for the writing by the “in use flag” cluster 6B, and shows whether the cluster 6B is using the separate cluster (cluster 6B) DMA 28B for data transfer.

A-(6) bit [1]: To be used by the writing by the “standby flag” cluster 6B, and shows whether the cluster 6B is currently setting the transfer list to the separate cluster (cluster 6A) DMA 28B.

FIG. 5 is based on the premise that the DMA 28A and the DMA 28B only have one channel, respectively. Such being the case, the same DMA cannot be simultaneously used by two clusters. Thus, provided is a status table that is differentiated based on which cluster the DMA belongs to and from which cluster the transfer list is written into the DMA so as to control the competing access from two clusters to the same DMA.

In order to implement the exclusive control of the DMA as described above, the cluster 6A needs to confirm the status of use of the DMA of the cluster 6B. Here, if the cluster 6A reads the “in-use flag” of the cluster 6B via the inter-cluster connection 12, the latency will be extremely large, and this will lead to the performance deterioration of the cluster 6A. Moreover, as described above, there is the issue of system failure of the cluster 6A that is associated with the fault of the cluster 6B.

Thus, the storage apparatus 10 sets the DMA status table including the “in-use flag” in the local memory of the respective clusters as (A/B-(3), (4), (5), (6)) so as to enable writing in the status table from other clusters.

A-(7) in FIG. 5 is a table in which the “completion status” is written by the DMA 28A of the cluster 6A, and A-(8) is a table in which the “completion status” is written by the DMA of the cluster 6B. The former table is used as for the internal data transfer of the cluster 6A, and the latter table is used for the data transfer from the cluster 6B to the cluster 6A.

A-(9) is a table for setting the priority among a plurality of masters in relation to the DMA 28A of the cluster 6A, and A-(10) is a table for setting the priority among a plurality of masters in relation to the DMA 28B of the cluster 6B. Explanation regarding the respective tables of the cluster A applies to the respective tables of the cluster B be setting the cluster B as the self-cluster and the cluster A as the other cluster.

A master is a control means (software) for realizing the DMA data transfer. If there are a plurality of masters, the DMA transfer job is achieved and controlled by the respective masters. The adjustment means in a case where the same jobs depending on a plurality of masters are competing in a DMA is the priority table.

The foregoing tables stored in the system memory 24A of the cluster 6A are set or updated by the MP 14A of the cluster 6A and the MP 14B of the cluster 6B during the startup of the system or during the storage data processing. The DMA 28A of the cluster 6A reads the tables of the system memory 24A and executes the DMA transfer within the cluster 6A and the DMA transfer to the cluster 6B.

The processing flow of the cluster 6A receiving the transfer of data from the DMA of the cluster 6B is now explained with reference to the flowchart shown in FIG. 6. When the MP 14A of the cluster 6A attempts to use the DMA 28B of the cluster 6B, the MP 14A executes the micro program and reads the “in-use flags” (bit [0] of A-(4), A-(5)) of the tables in the areas pertaining to the status of the DMA 28B of the cluster 6B, respectively, and determines whether they are both “0” (600).

If a negative result is obtained in this determination, it means that the DMA of the cluster 6B is being used, and the processing of step 600 is repeatedly executed until the value of both flags becomes “0”; that is, until the DMA becomes an unused status.

Subsequently, at step 602, the MP 14A access the cluster 6B, sets “1” as the “standby flag” to the bit [1] of the status table B-(6) of that local memory, and thereby obtains the setting right of the transfer list to the DMA 28B of the cluster 6B.

The MP 14A also writes “1” as the “standby flag” to the bit [1] of the status table A-4 of the local memory 24A. If the standby flag is raised, this means that the cluster 6A is currently setting the DMA 28B of the cluster 6B.

Subsequently, the MP 14A reads the bit [1] of area A-(5) pertaining to the status of the DMA 28B of the cluster 6B, and determines whether the “standby flag” is “1” (604). A-(4) is used when the cluster 6A controls the DMA of the cluster 6B, and A-(5) is used when the cluster 6B controls the DMA of the self cluster.

If this flag is “0,” [the MP 14A] determines that the other masters also do not have the setting right of the transfer list to the DMA 28B, and proceeds to step 606.

Meanwhile, if the flag is “1” and the cluster 6A and the cluster 6B simultaneously have the right of use of the DMA 28B of the cluster 6B, the routine proceeds from step 604 to step 608. If the priority of the cluster 6A master is higher than the priority of the cluster 6B master, the cluster 6A master returns from step 608 to step 606, and attempts to execute the data transfer from the DMA 28B of the cluster 6B to the cluster 6A.

Meanwhile, if the priority of the cluster 6B master is higher, the cluster 6B master notifies a DMA error to the micro program of the cluster 6A (master) to the effect that the data transfer command from the cluster 6A master to the DMA 28B of the cluster 6B cannot be executed (611).

At step 606, the MP 14A sets “in-use flag”=“1” to the bit [0] of the status tables A-(4), A-(6) of the local memory 24B of the cluster 6B, and secures the right of use against the DMA 28B of the cluster 6B.

Subsequently, at step 607, the MP 14A sets a transfer list in the DMA descriptor table of the local memory 24B of the cluster 6B.

Moreover, the MP 14A starts up the DMA 28B of the memory 6B, the DMA 28B that was started up reads the transfer list, reads the data of the system memory 24B based on the transfer list that was read, and transfers the read data to the local memory 24A of the cluster 6A (610).

If the DMA 28B normally writes data into the cluster 6A, the DMA 28B writes the completion write into the completion status table allocated to the DMA 28B of the cluster B of the system memory 24A.

Subsequently, the MP 14A checks the completion status of this table; that is, checks whether the completion write has been written (612).

If the completion write has been written, the MP 14A determines that the data transfer from the cluster 6B to the cluster 6A has been performed correctly, and proceeds to step 614.

At step 614, the MP 14A sets “0” to the bit [0] related to the in-use flag of the status table B-(6) of the system memory 24B (table written by the cluster 6A and which shows the DMA status of the cluster 6B) and the status table A-(4) of the system memory 24A of the cluster 6A (table written by the cluster 6A and which shows the DMA status of the cluster 6B).

Subsequently, at step 616, the MP 14A sets “0” to the bit [1] related to the standby flag of these tables, and releases the access right to the DMA 28B of the cluster 6A.

If the cluster 6B is to use the DMA 28B on its own, the MP 14A sets “1” to the bit [0] of A-(5), B-(3), and notifies the other masters that the cluster 6B itself owns the right of use of the DMA 28B of the cluster 6B.

At step 612, if the MP 14A is unable to confirm the completion write, the MP 14 determines this to be a time out (618), and notifies the transfer error of the DMA 28B to the user (610).

The processing of the MP 14A of the cluster 6A shown in FIG. 6 setting a transfer list in the DMA 28B of the cluster 6B and starting up the DMA 28B is now additionally explained below.

FIG. 7 shows an example of a transfer list, and the MP 14A sets the transfer list in the system memory 28B according to the transfer list format. This transfer list includes a transfer option, a transfer size, an address of the system memory 24B to become the transfer source of data, an address of the system memory 24A to become the transfer destination of data, and an address of the next transfer list. These items are defined with an offset address. The transfer list may also be stored in the cache memory. As a result of using the offset address as the base address, the address of the memory space is decided.

When the MP 14A is to set the transfer list in the local memory 24B of the cluster 6B, an address on the memory space in which a descriptor (transfer list) is arranged in the DMA register (descriptor address) is set. An example of such address setting table for setting an address in the register is shown in FIG. 8.

The DMA 28B refers to this register to learn of the address where the transfer list is stored in the local memory, and thereby accesses the transfer list. In FIG. 8, the size is the data amount that can be stored in that address.

When the MP 14A is to start up the DMA 28B, it writes a start flag in the register (start DMA) of the DMA 28B. The DMA 28B is started up once the start flag is set in the register, and starts the data transfer processing. FIG. 9 shows an example of this register, and the offset address value is the address in the memory space of the register, and the size is the data amount that can be stored in that address.

The setting of the address for writing the completion write into the cluster 6A is performed using the MMIO area of the NTB, and performed to the MMIO area of the cluster 6B DMA. The MP 14A subsequently sets the address of the local memory 24A to issue the completion write in the register (completion write address) shown in FIG. 10 after the DMA 28B transfers the data transfer. This setting must be completed before the DMA 28B starts the data transfer. The value of the offset address is the location in the memory space of the register, and the size is the data amount that can be stored in that address.

The cluster 6A provides, in the system memory 24A, an area for writing the completion status write of the error notification based on the abort of the DMA 28B as the DMA completion status table (A-8) after the completion of the DMA transfer from the cluster 6B as described above.

The DMA of the storage apparatus is equipped with a completion status write function, and not the interruption function, as the method of notifying the completion or error of the DMA transfer to the cluster of the transfer destination.

Incidentally, the present invention is not denying the interruption method, and the storage apparatus may adopt such interruption method to execute the DMA transfer completion notice from the cluster 6B to the cluster 6A.

When transferring data from the cluster 6B to the cluster 6A, if the completion write is written into the memory of the cluster 6B and data is read from the cluster 6A, since this read processing must be performed across the connection means between a plurality of clusters, there is a problem in that the latency will increase.

Consequently, the completion status area is allocated in the memory 24A of the cluster 6A in advance, and the master of the cluster 6A executes the completion write from the DMA 28B of the cluster 6B to this area while using software to restrict the write access to this area. Thus, as a result of the master of the cluster 6A reading this area without any reading being performed between the clusters, the completion of the DMA transfer from the cluster 6B to the cluster 6A can thereby be confirmed.

At step 604 and step 608 of FIG. 6, if the masters of the cluster 6A and the cluster 6B simultaneously own the access right to the DMA 28B of one channel of the cluster 6B, the right of use of the DMA will be allocated to the master with the higher priority.

This is because, even though the storage apparatus 10 authorized the cluster 6A to perform the write access to the DMA 28B of the cluster 6B, if the cluster 6A and the cluster 6B both attempt to use the DMA 28B, the DMA 28B will enter a competitive status, and the normal operation of the DMA cannot be guaranteed. The foregoing process is performed to prevent this phenomenon. Details regarding the priority processing will be explained later.

Meanwhile, if the number of DMAs to be mounted increases and the access from the cluster 6A and the cluster 6B is approved for all DMAs, this exclusive processing will be required for each DMA, and there is a possibility that the processing will become complicated and the I/O processing performance of the storage apparatus will deteriorate.

Thus, the following embodiment explains a system that is able to avoid the competition of a plurality of masters in the same DMA in substitute for the exclusive processing based on priority in a mode where a DMA configured from a plurality of channels exist in the cluster.

FIG. 11 is a diagram explaining this embodiment. The cluster 6A and the cluster 6B are set with a master 1 and a master 2, respectively. Each cluster of the storage apparatus has a plurality of DMAs; for instance, DMAs having four channels. The storage apparatus grants the access right to the DMA channel 1 and the DMA channel 2 among the plurality of DMAs of the cluster 6A to the master of the cluster 6A, and similarly allocates the DMA channel 3 and the DMA channel 4 to the master of the cluster 6B.

Moreover, the DMA channel 1 and the DMA channel 2 among the plurality of DMAs of the cluster 6B are allocated to the master of the cluster 6A, and the DMA channel 3 and the DMA channel 4 are allocated to the master of the cluster 6B. The foregoing allocation is set during the software coding of the clusters 6A, 6B.

Accordingly, the master of the cluster 6A and the master of the cluster 6B are prevented from competing their access rights to a single DMA in the cluster 6A and the cluster 6B.

Specifically, in the cluster 6A, the DMA channel 1 is used by the master 1 of the cluster 6A, the DMA channel 2 is used by the master 2 of the cluster 6A, the DMA channel 3 is used by the master 1 of the cluster 6B, and the DMA channel 4 is used by the master 2 of the cluster 6B.

Moreover, in the cluster 6B, the DMA channel 1 is used by the master 1 of the cluster 6A, the DMA channel 2 is used by the master 2 of the cluster 6A, the DMA channel 3 is used by the master 1 of the cluster 6B, and the DMA channel 4 is used by the master 2 of the cluster 6B.

Each of the plurality of DMAs of the cluster 6A is allocated with a table stored in the system memory 24A within the same cluster as shown with the arrows of FIG. 11. The same applies to the cluster 6B.

The master of the cluster 6A uses the DMA channel 1 or the DMA channel 2 and refers to the transfer list table (self-cluster (cluster 6A) DMA descriptor table to be written by the self-cluster) (A-1) and performs the DMA transfer within the cluster 6A.

Here, the master of the cluster 6A refers to the cluster 6A DMA status table (A-3) of the system memory 24A.

When the master of the cluster 6B requires data of the cluster 6A, it writes a startup flag in the register of the DMA channel 3 or the DMA channel 4 of the cluster 6A. The method of choosing which one is as follows. Specifically, the master of the cluster 6B is set to constantly use the DMA channel 3, set to use the DMA channel 4 if it is unable to use the DMA channel 3 due to the priority relationship, and set to wait until a DMA channel becomes available if it is also unable to use the DMA channel 4. Otherwise, the relationship between the DMA and the master (hardware) is set to 1:1 during the coding of software.

Consequently, the DMA channel 3 of the cluster 6A DMA-transfers the data from the cluster 6A to the cluster 6B according to the transfer list stored in the cluster 6B table 110. Moreover, the DMA channel 4 of the cluster 6A DMA-transfers the data from the cluster 6A to the cluster 6B according to the transfer list stored in the cluster 6B table 112.

These tables are set or updated with the transfer list by the master of the cluster 6B.

In the cluster 6B, the access right of the master of the cluster 6A is allocated to the DMA channel 1 and the DMA channel 2. An exclusive right of the master of the cluster 6B is granted to the DMA channel 3 and the DMA channel 4. The allocation of the tables and the DMA channels is as shown with the arrows in FIG. 11.

The foregoing priority is now explained. FIG. 12 shows a priority table prescribing the priority in cases where access from a plurality of masters is competing in the same DMA. Since it is physically impossible for two or more masters to simultaneously start up and use a single DMA, the priority table is used to set the priority of the master's right of using the DMA. Incidentally, in FIG. 11, the respective DMA channel tables are provided with a DMA channel completion write area.

FIG. 12 shows the format of the priority tables A-9, B-10 (FIG. 5) regarding the DMA 28A of the cluster 6A (refer to FIG. 5), and FIG. 13 shows the format of the priority tables A-10, B-9 regarding the DMA 28B of the cluster 6B (refer to FIG. 5). This table includes a value for identifying the master, and priority setting. The smaller the value, the higher the priority. The priority is defined as the order or priority among the plurality of masters of the clusters 6A, 6B in relation to a single DMA. FIG. 14 is a table defining a total of four masters; namely, master 0 and master 1 of the cluster 6A, and master 0 and master 1 of the cluster 6B. The master is identified based on a 2 bit (value) as shown in FIG. 14. Since a total of 8 bits exist for defining the masters (refer to FIG. 12), as shown in FIG. 15, the priority table sequentially maps the four masters respectively identified with 2 bits in the order of priority.

FIG. 15 is a priority table of the master 28A of the cluster 6A. According to this priority table, the level of priority is in the following order: master 1 of cluster 6A>master 0 of cluster 6A>master 0 of cluster 6B>master 1 of cluster 6B.

Accordingly, the micro program of the cluster 6A refers to this priority table when access from the plurality of masters is competing in the same DMA, and grants the access right to the master with the highest priority.

The priority levels are prepared in a quantity that is equivalent to the number of masters. In the foregoing example, four priority levels are set on the premise that the cluster 6A has two masters and the cluster 6B has two masters. If the number of masters is to be increased, then the number of bits for setting the priority will also be increased in order to increase the number of priority levels.

The micro program determines that a plurality of masters are competing in the same DMA as a result of the standby flag “1” being respectively set in the plurality of status tables of that DMA. For example, in FIG. 5, both A-3 and A-6 are of a status where the standby flag has been set.

Meanwhile, in the storage apparatus, there are cases where the priority is once set and thereafter changed. For example, when exchanging the firmware in the cluster 6A, the master of the cluster 6A will not use the DMA 28A at all during the exchange of the firmware.

Thus, the DMA of the cluster 6A is preferentially allocated to the master of the cluster 6B on a temporary basis so that the latency of the cluster 6B to use the DMA of the cluster 6A is decreased.

The priority table is set upon booting the storage apparatus. During the startup of the storage apparatus, software is used to write the priority table into the memory of the respective clusters. This writing is performed from the cluster side to which the DMA allocated with the priority table belongs. For example, the writing into the table A-9 is performed with the micro program of the cluster 6A and the writing into the table A-10 is performed with the microgram of the cluster 6B.

Even if a plurality of clusters exist in each cluster, the setting, change and update of the priority is performed by one of such masters. If an unauthorized master wishes to change the priority, it requests such priority change to an authorized master.

The flowchart for changing the priority is now explained with reference to FIG. 16.

The priority change processing job includes the process of identifying the priority change target DMA (1600).

The plurality of masters of the cluster to which this DMA belongs randomly selects the job execution authority and determines whether there is any master with the priority change authority (1602). If a negative result is obtained in this determination, the priority change job is given to the authorized master (1604).

If a positive result is obtained in this determination, the master with the priority change authority determines whether “1” is set as the in-use flag of the status table allocated to the DMA in which the priority is to be changed. If the flag is “1,” since the priority cannot be changed since the DMA is being used in the data transfer, the processing is repeated until the flag becomes “0” (1606).

If the data transfer of the target DMA is complete and data regarding that DMA is transferred, then the in-use flag is released and becomes “0,” and step 1606 is passed. Subsequently, the master sets “1” as the standby flag of the status table allocated to the DMA, and secures the access right to the DMA (1608).

At step 1610, if a standby flag is set by a master that is separate from the job in-execution master in the status table of the priority change target DMA to be written by the separate master and which is stored in a memory of the cluster to which the master that is executing the priority change job belongs, the priority change job in-execution master refers to the priority change table of the target DMA to be written by that master, compares the priority of the separate master and the priority of the master to perform the priority change job, and proceeds to step 1620 if the priority of the former is higher.

At step 1620, the priority change job in-execution master releases the standby flag; that is, sets “0” to the standby flag of the target DMA set by the job in-execution master since the transfer list to the target DMA is being set by the separate master, and subsequently proceeds to the processing for starting the setting, change and update of the priority regarding a separate DMA (1622), and then returns to step 1602.

Meanwhile, if the priority of the job in-execution master is higher in the processing at step 1610, this master sets “1” as the in-use flag in the status table of the “target DMA” to be written by that master and the “target DMA” to be written by a separate master write, and locks the target DMA in the priority change processing (1612).

At subsequent step 1614, if “1” showing that the DMA is being used is set in the in-use flag of all DMAs belonging to the cluster, the job in-execution master deems that the locking of all DMAs belonging to the cluster is complete, and performs priority change processing to all DMAs belonging to that cluster (1616), thereafter clears the flag allocated to all DMAs (1618), and releases all DMAs from the priority change processing.

Accordingly, the priority change and update processing of all DMAs belonging to a plurality of clusters is thereby complete.

FIG. 17 is a modified example of FIG. 11, and is a block diagram of the storage system in which each cluster has a plurality of DMA channels (channels 1 to 4), each cluster is set with a plurality of masters (master 1, master 2), and the operation right of each DMA channel is set in cluster units. Since the number of masters of the overall storage apparatus shown in FIG. 17 is less than the number of DMA channels of the overall storage apparatus, if the operation right of the master is allocated to the DMA channel in master units, the competition among the plurality of masters in relation to the DMA channel can be avoided. Nevertheless, as with this embodiment, if the operation right of the master is allocated to the DMA channel in cluster units including a plurality of master, exclusive processing between the plurality of masters will be required. Exclusive control using the priority table is applied in FIG. 17.

In the cluster 6A, the DMA channel 1 and the DMA channel 2 are set with the access right of the cluster 6A, and the DMA channel 3 and the DMA channel 4 are set with the access right of the cluster 6B. In the cluster 6B, the DMA channel 1 and the DMA channel 2 are set with the access right of the cluster 6A, and the DMA channel 3 and the DMA channel 4 are set with the access right of the cluster 6B.

Both the cluster 6A and the cluster 6B are set with a control table to be written by the self-cluster and a control table to be written by the other cluster. Each control table is set with a descriptor table and a status table of the DMA channel.

The cluster A-DMA channel 1 table is set with a self-cluster DMA descriptor table (A-(1)) to be written by the self-cluster (cluster 6A), and a self-cluster DMA status table (A-(3)) to be written by the self-cluster. The same applies to the cluster A-DMA channel 2 table.

The cluster A-DMA channel 3 table is set with a self-cluster (cluster 6A) DMA descriptor table (A-(7)) to be written by the cluster B, and a self-cluster (cluster 6A) DMA status table (A-(6)) to be written by the cluster B. The same applies to the cluster A-DMA channel 4 table. This table configuration is the same in the cluster 6B as with the cluster 6A, and FIG. 17 shows the details thereof.

In addition, the cluster 6A is separately set with a control table that can be written by the self-cluster (cluster 6A) and which is used for managing the usage of both DMA channels 1 and 2 of the cluster 6B. Each control table is set with another cluster (cluster 6B) DMA status table (A-(4)) to be written by the self-cluster (cluster 6A). This table configuration is the same in the cluster 6B, and FIG. 17 shows the details thereof.

Although the foregoing embodiment explained a case where data is written form the cluster 6B into the cluster 6A based on DMA transfer, the reverse is also possible as a matter of course.

The present invention can be applied to a storage apparatus comprising a plurality of clusters as processing means for providing a data storage service to a host computer, and having improved redundancy of a data processing service to be provided to a user. In particular, the present invention can be applied to a storage apparatus and its data transfer control method that is free from delays in cluster interaction processing and system crashes caused by integration of multiple clusters even when it is necessary to transfer data in real time between multiple clusters in a storage apparatus including multiple clusters.

Another embodiment of the DMA startup method is now explained. When the MP 14A is to start up the DMA 28B at step 610 of FIG. 6 and in FIG. 9, explained was a case where a start flag is written in the register (start DMA) of the DMA 28B, and the DMA 28B is started up when the start flag is set in the register, and starts the data transfer processing. The processing of this example also applies to the operation of the MP 14B and the DMA 28A in the course of starting up the DMA 28A.

The embodiment explained below shows another example of the DMA startup method. Specifically, this startup method sets the number of DMA startups in the DMA counter register. The DMA refers to the descriptor table and executes the data write processing in the number of the value that is designated in the register. When the MP executes a micro program and sets a prescribed numerical value in the DMA register counter, the DMA determines the differential and starts up in the number of times of the value corresponding to that differential, refers to the descriptor table, and executes the data write processing.

The memory 24A of the cluster 6A (cluster A) and the memory 24B of the cluster 6B (cluster B) are respectively set with a counter table area to be referred to by the MP upon controlling the DMA startup. The MP reads the value of the counter table and sets the read value in the DMA register of the cluster to which that MP belongs.

FIG. 18 is a block diagram of the storage apparatus for explaining the counter table. A-(11) and B-(11) are DMA 28A counter tables to be written by both the MP 14A of the cluster A and the MP 14B of the cluster B, and A-(12) and B-(12) area DMA 28B counter tables to be written by both the MP 14A of the cluster A and the MP 14B of the cluster B.

FIG. 19 shows an example of the DMA counter table. The counter table includes the location in the memory as an offset address in which the number of DMA startups is written, and the size of the write area is also defined therein. The DMA startup processing is now explained with reference to the flowchart. The flowchart is now explained taking a case where the MP 14A is to start up the DMA 28B of the cluster B (6B). The MP 14A and the MP 14B respectively execute the flowchart shown in FIG. 20 based on a micro program. When the MP 44A starts the DMA 28A startup control processing, it refers to the counter table shown in A-(12), and reads the setting value that is set in the DMA 28B register (2000). Subsequently, the MP 14A write the value obtained by adding the number of times the DMA 22B is to be started up to the read value in A-(12) (2002), and also writes this in B-(12) (2004).

When the MP 14B detects the update of B-(12), it determines whether the DMA 28B is being started up by referring to the DMA status register, and, if the DMA 28B is of a startup status, waits for the startup status to end, proceeds to step 2008, and reads the value of B-(12). The MP 14B thereafter writes the read value in the counter register of the DMA 28B.

When the counter register is updated, the DMA 28B determines the differential with the value before the update, and starts up based on the differential.

According to the method shown in FIG. 20, the startup of the DMA of the second cluster can be realized for the data transfer from the second cluster to the first cluster only with the sending and receiving of a write command without having to send and receive a read command between the cluster A (6A) and the cluster B (6B).

If the MP 28B of the cluster B requests the data transfer to the cluster A, at step 2000, the MP 28B refers to B-(11). In addition, if the MP 28A is to realize the data transfer in its own cluster, it refers to A-(11), and, if the MP 28B is to realize the data transfer in its own cluster, it refers to B-(12).

A practical application of the data transfer method of the present invention is now explained. In a computer system including a plurality of clusters, data that is written from the host computer regarding one cluster is written redundantly in the other cluster via one cluster. FIG. 21A is a conventional computer system showing the foregoing situation, and corresponds to FIG. 1. The data 2100 sent from the host 24 to the cluster 6A passes through the route 2102 of the host controller 16A, the switch circuit 20A, and the bridge circuit 22A, in that order, and is stored in the cache memory 24A. Moreover, the DMA 28A of the switch circuit 18A sends the data 2101 from the host computer 2A to the separate cluster 6B via the NTB 26A and the connection path 12 (2104).

As shown in FIG. 21B, when the host computer 2A finishes sending all data, it writes a completion write (cmpl) which shows the completion of data sending in the cache memory 24 via the route 2102 (2105). As a result of the MP 14A reading the completion write of the cache memory 24 via the bridge circuit 22A (2106), the data 2100 of the cache memory 24A is decided; that is, all data will be written into the cache memory 24A without remaining in the buffer of the route 2102.

Meanwhile, since the host 2A is unable to write the completion write into the separate cluster 6B, the data 2101 sent to the separate cluster remains in an undecided status; that is, the status will be such that the MP 14 is unable to confirm whether all data have reliably reached the cache memory 24B.

Thus, as shown in FIG. 21C, when the MP 14A sends the read request 2110 to the cluster 6B, even if the data 2101 is retained in the buffer on the path from the switch circuit 20B to the cache memory 24A, it will be forced out to the cache memory 24B by the read request 2110. Consequently, as a result of the MP 14A confirming the reply of the read request, it determines that the data was decided in the other cluster 6B as well.

Then, as shown in FIG. 21D, since the MP 14A was able to confirm that the data has been decided in both the self cluster 6A and the other cluster 6B, the MP 14A sends a good reply 2120 to the host computer 2A which shows that the writing ended normally.

The write processing from the host computer is completed based on the steps shown in FIG. 21A to FIG. 21D. However, in FIG. 21D, if there is a read request from the cluster A to the cluster B, it will result in a completion time out as described above, there is the issue of system failure of the cluster 6A that is associated with the fault of the cluster 6B.

Thus, the application of the present invention is effective in order to decide the data from the host computer to the other cluster while overcoming the foregoing issue. Specifically, as shown in FIG. 22A, when the MP 14A of the cluster 6A issues a startup command 2200 to the DMA 28B of the cluster 6B, even if the data 2101 is retained in the buffer in the middle of the data transfer route of the cluster 6B, that data will be forced out to the switch circuit 20B in which the DMA 28B exists (2201). Then, as shown in FIG. 22B, if the DMA 28B is started up, the read request 2204 is issued from the DMA 28B to the descriptor table 2202 of the memory 24B, and the data 2101 of the bridge circuit 22B is forced out by the read request and sent to the memory 24B (2206).

The DMA 28B additionally reads the dummy data 2208 in the memory 24B based on the descriptor table 2202, and sends this to the memory 24A of the cluster 6A (2210). As a result of the dummy data 2210 being stored in the memory 24A, the MP 14A is able to confirm that the data of the other cluster 6B has been decided. Incidentally, as shown in FIG. 22C, after the DMA 28B transfers the dummy data 2208, it may send the completion write 2212 to the memory 24A (2214), and thereby set the completion of the sending of data in the MP 14A of the cluster 6A.

As shown in FIG. 22D, when the MP 14A constantly performs polling to the dummy data to be DMA-transferred to the memory 24A (2230) and reads the dummy data 2208, it determines that the data to the other cluster has been decided. After confirming the dummy data, the MP 14A clears the storage area of the dummy data (for instance, sets all bits to “0”). If time out occurs during the polling, the MP 14A determines that some kind of fault occurred in the other cluster. Moreover, as a result of the MP 14A confirms the completion write (CMPL) from the memory 24A, it is able to obtain the status information of the DMA 28B of the other cluster.

When the MP 14A determines that the data of the other cluster has been decided, as with FIG. 21D, it sends a write good reply to the host computer 2A.

Incidentally, although FIG. 22A to FIG. 22D explained a case of the data from the host computer 2A being redundantly written into the cluster 6A and the cluster 6B, this method may also be applied upon deciding the data to be written from the host computer 2A into the cluster 6B.

### BRIEF DESCRIPTION OF DRAWINGS

FIG. 1 is a hardware block diagram of a storage system comprising an example of a storage system according to an embodiment of the present invention.

FIG. 2 is a hardware block diagram of a storage system comprising a storage apparatus according to the second embodiment.

FIG. 3 is a hardware block diagram of a storage system comprising a storage apparatus according to the third embodiment.

FIG. 4 is a hardware block diagram of a storage system explaining the data transfer flow of the storage apparatus illustrated in FIG. 1.

FIG. 5 is a block diagram explaining the details of a control table in a local memory of the storage apparatus illustrated in FIG. 1.

FIG. 6 is a flowchart explaining the data transfer flow in the storage apparatus illustrated in FIG. 1.

FIG. 7 is a table showing an example of a transfer list.

FIG. 8 shows an example of a table configuration of a register for setting an address storing the transfer list to a DMA controller.

FIG. 9 shows an example of a table configuration of a register for setting an address storing a startup request to a DMA controller.

FIG. 10 shows an example of a table configuration of a register for setting a completion status to a DMA.

FIG. 11 is a block diagram showing the correspondence between a plurality of DMA controllers and a plurality of control tables existing in the local memory.

FIG. 12 shows an example of a priority table of a first cluster.

FIG. 13 shows an example of a priority table of a second cluster.

FIG. 14 shows an example of a table for identifying a plurality of masters.

FIG. 15 shows an example of a priority table mapped with a plurality of masters and which prescribes the priority thereof.

FIG. 16 is a flowchart for changing the priority of a plurality of masters in the DMA controller.

FIG. 17 is a block diagram of a modified example of FIG. 11.

FIG. 18 is a block diagram of the storage apparatus for explaining the DMA counter table.

FIG. 19 is an example of the DMA counter table.

FIG. 20 is a flowchart explaining the DMA startup processing.

FIG. 21A is a block diagram of the storage apparatus for explaining the first step of a conventional method to be referred to in order to understand the other embodiments of the data transfer method of the present invention.

FIG. 21B is a block diagram of the storage apparatus for explaining the second step of the foregoing conventional method.

FIG. 21C is a block diagram of the storage apparatus for explaining the third step of the foregoing conventional method.

FIG. 21D is a block diagram of the storage apparatus for explaining the fourth step of the foregoing conventional method.

FIG. 22A is a block diagram of the storage apparatus for understanding the other embodiments of the data transfer method of the present invention.

FIG. 22B is a block diagram of the storage apparatus for explaining the step subsequent to the step of FIG. 22A.

FIG. 22C is a block diagram of the storage apparatus for explaining the step subsequent to the step of FIG. 22B.

FIG. 22D is a block diagram of the storage apparatus for explaining the step subsequent to the step of FIG. 22C.

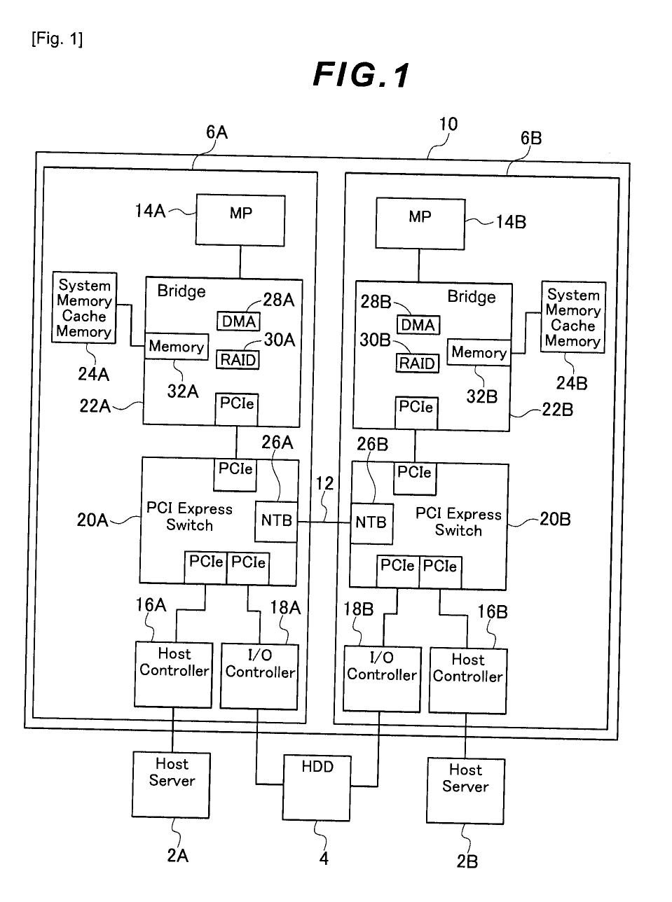

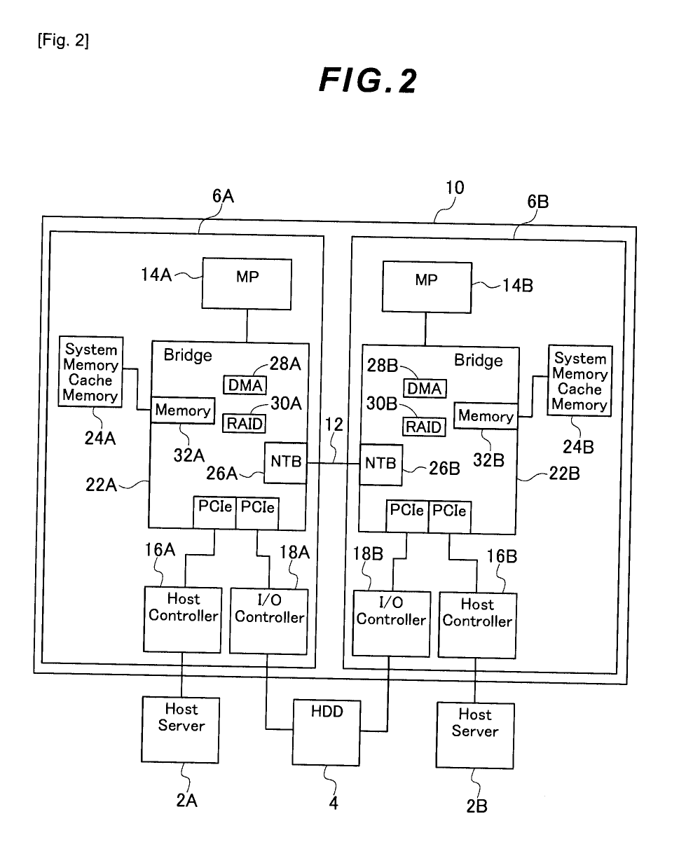

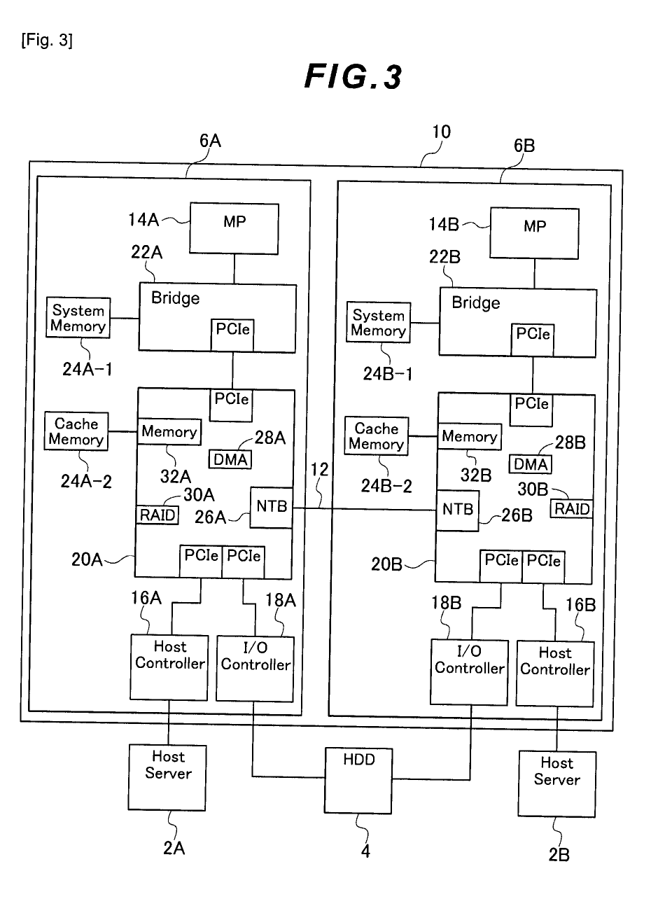

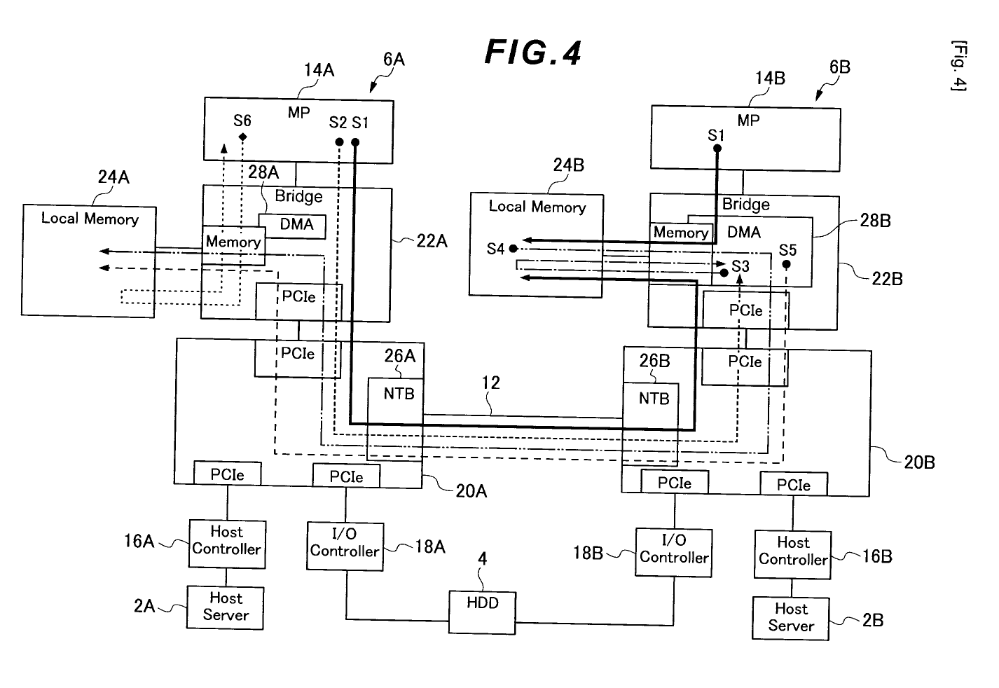

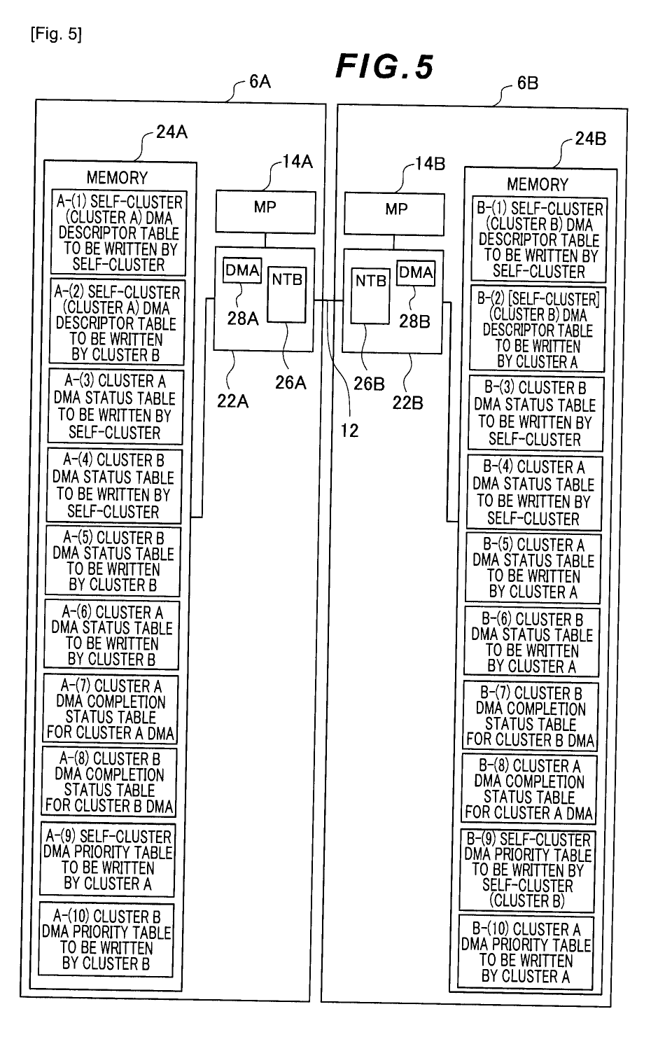

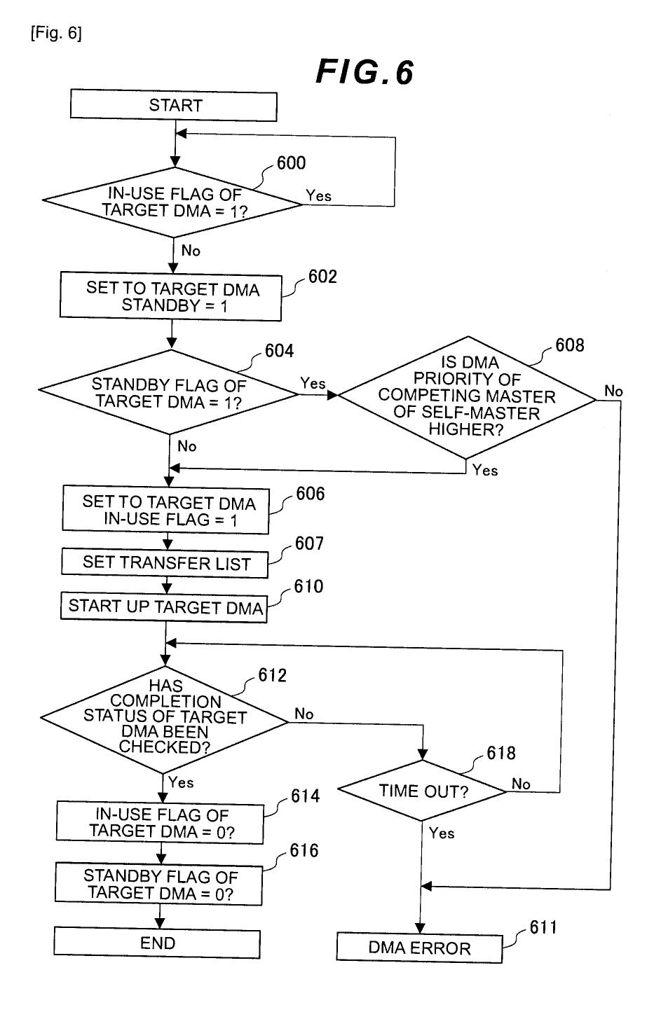

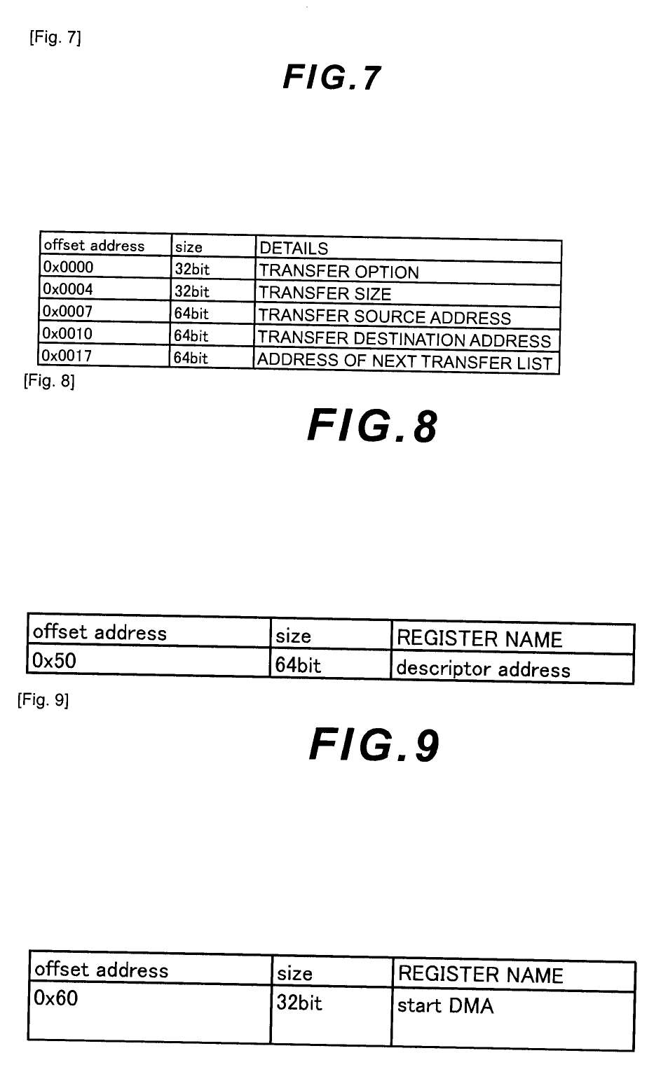

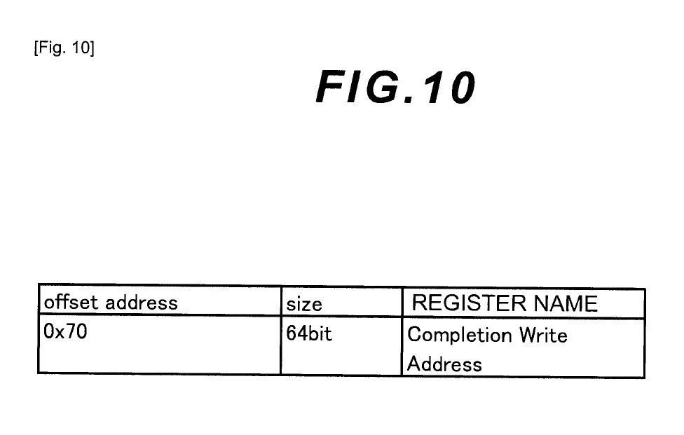

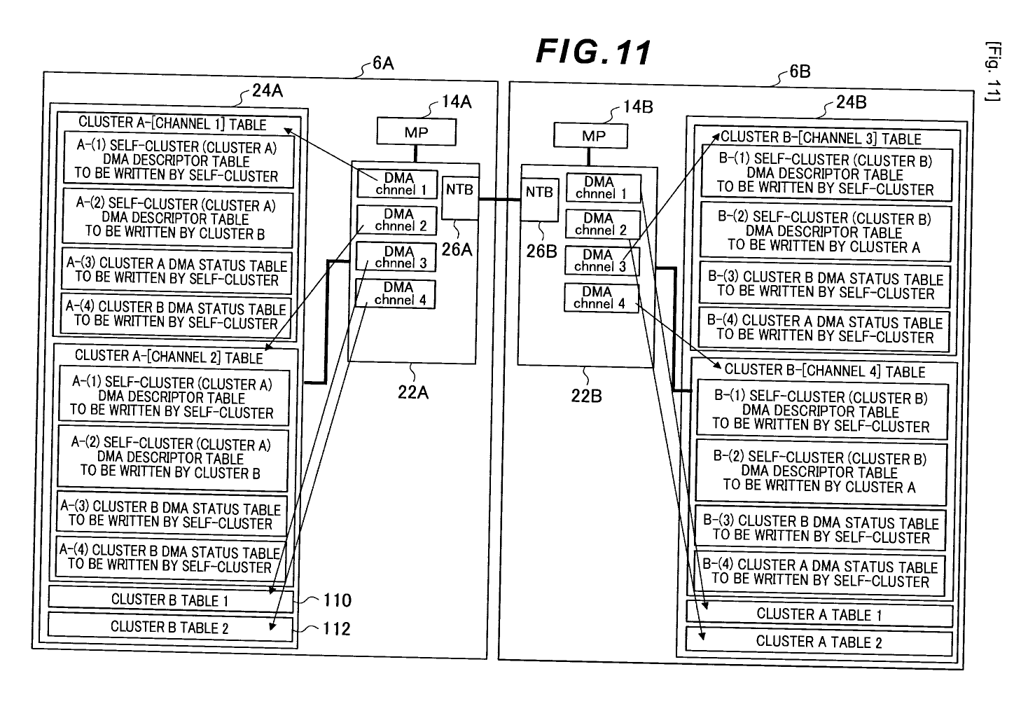

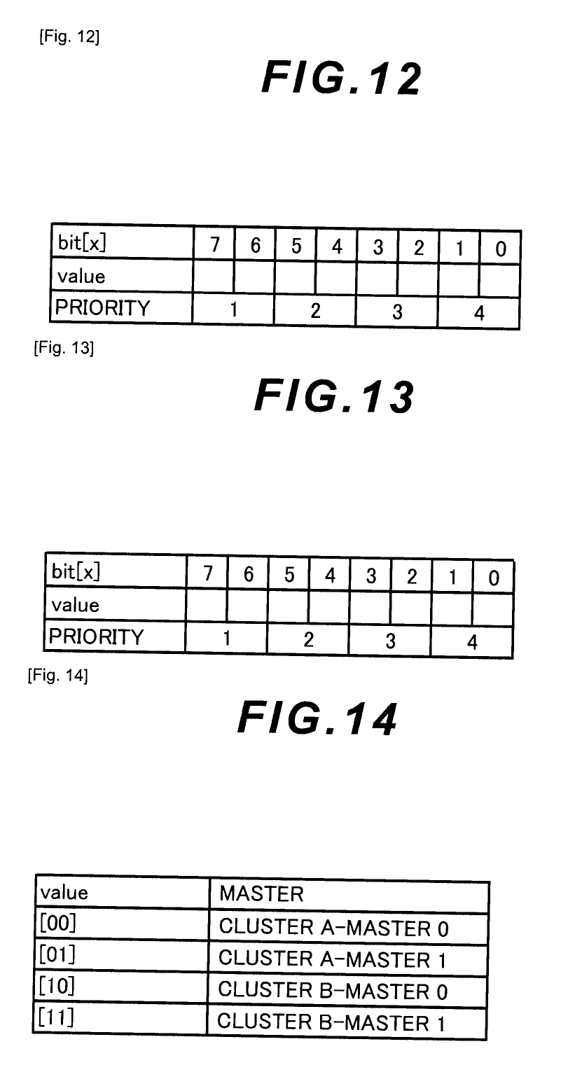

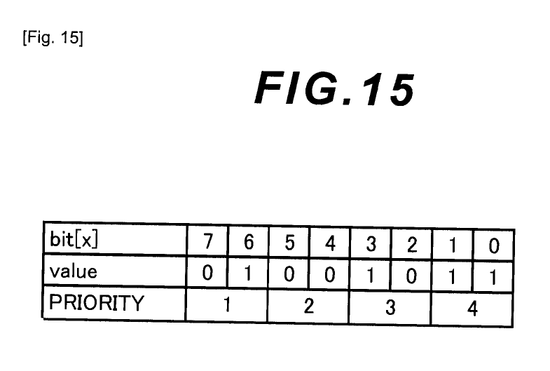

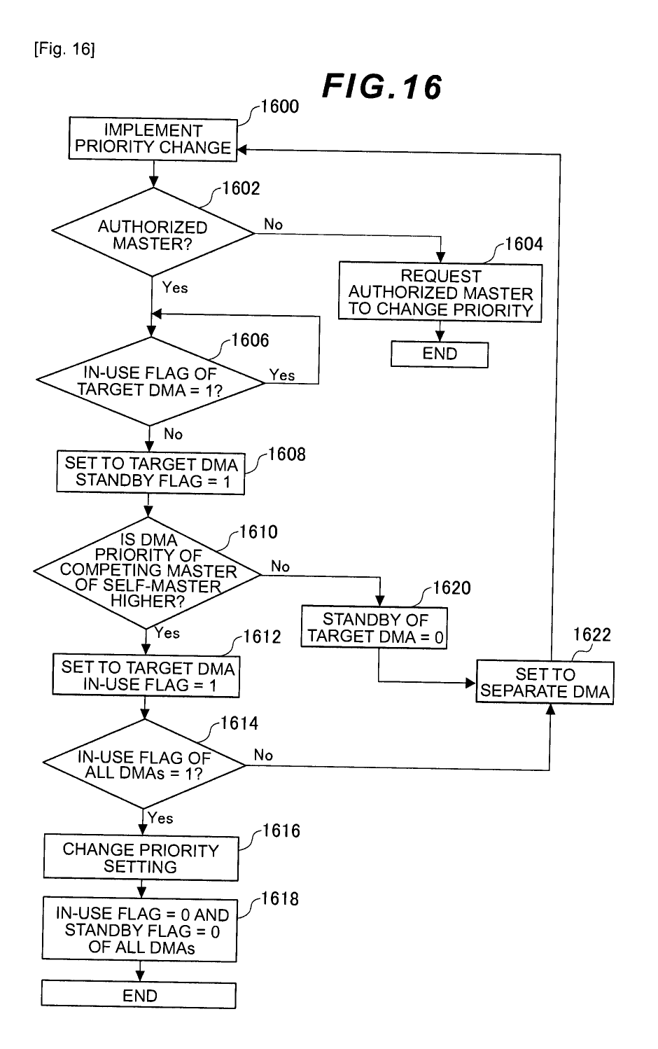

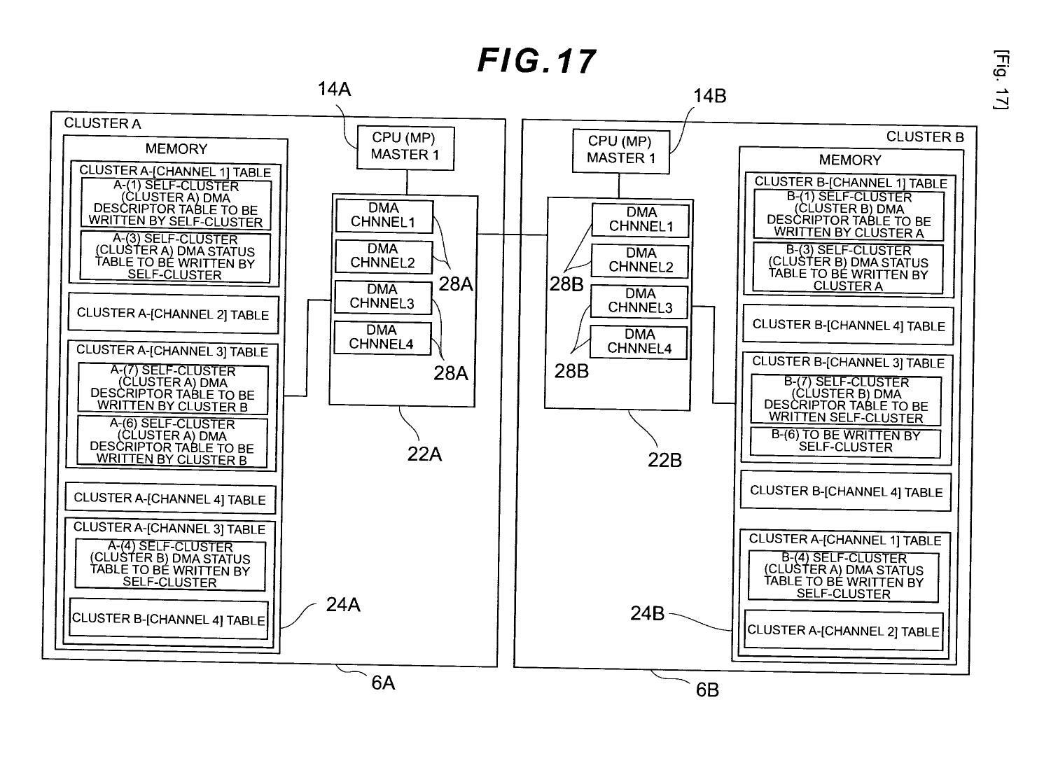

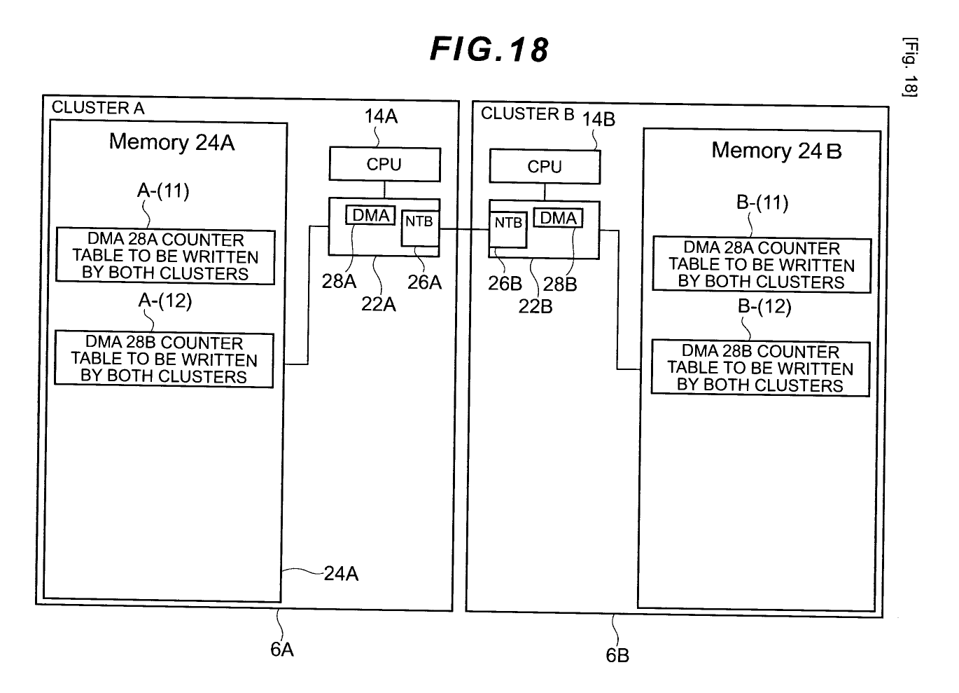

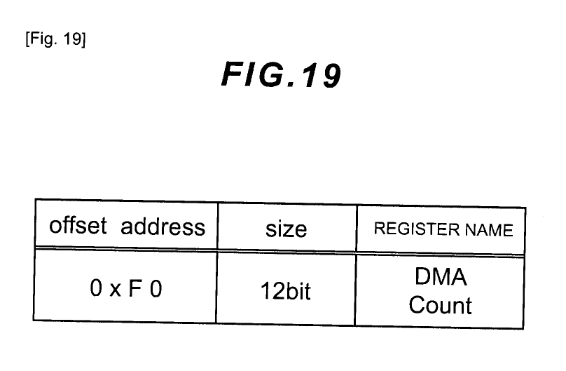

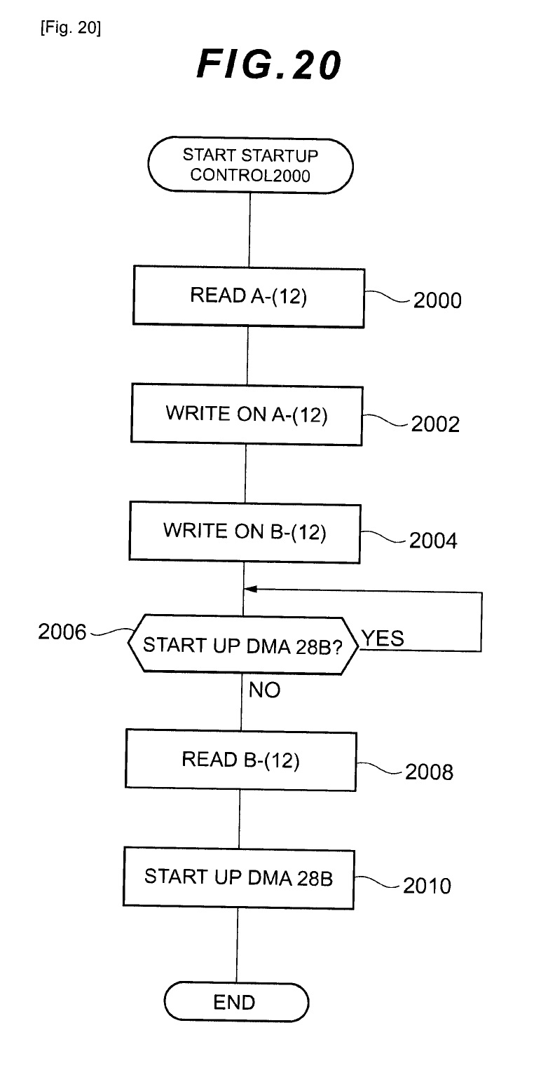

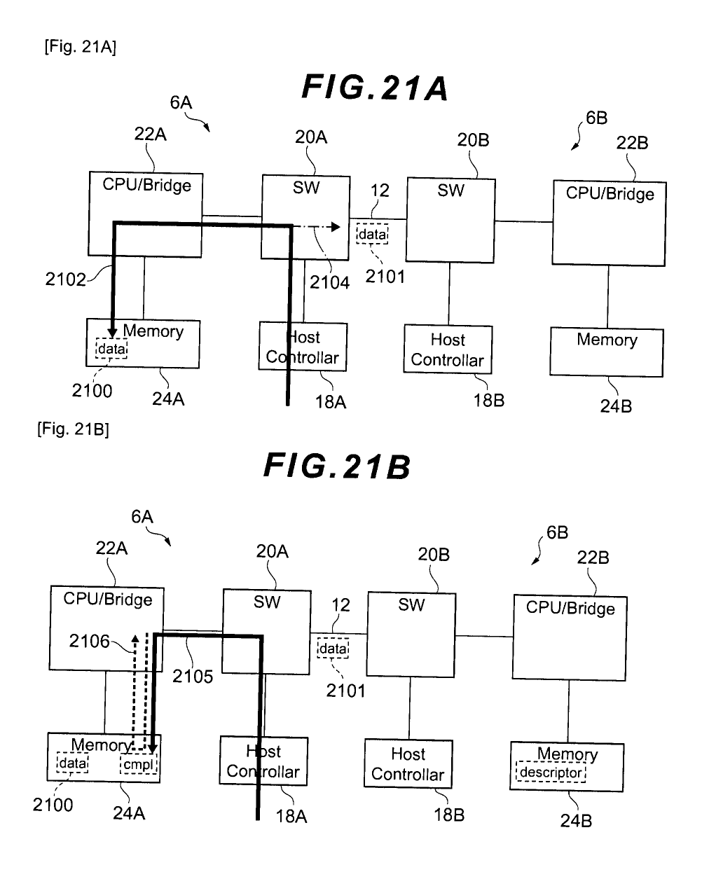

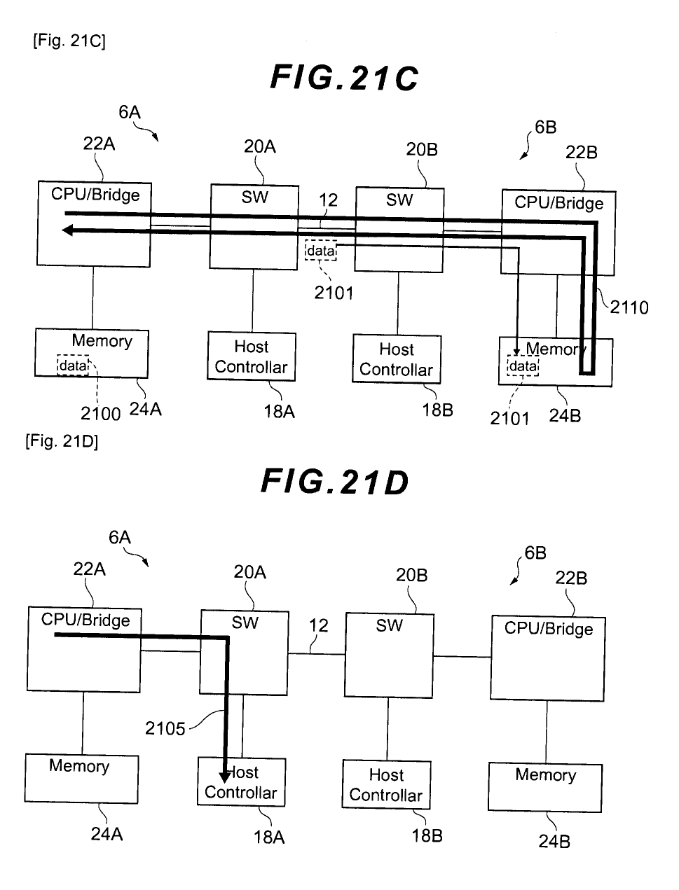

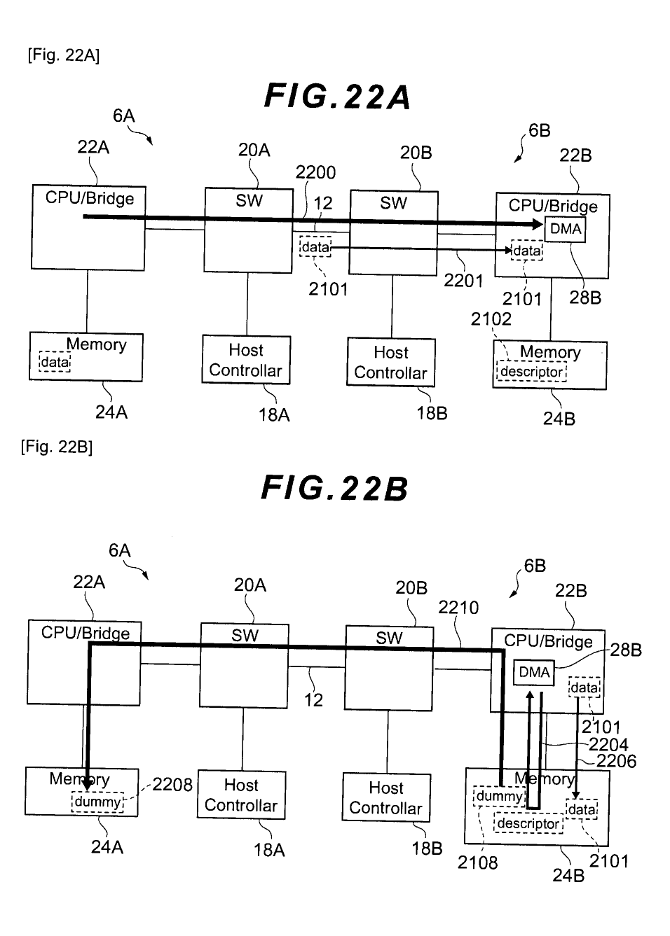

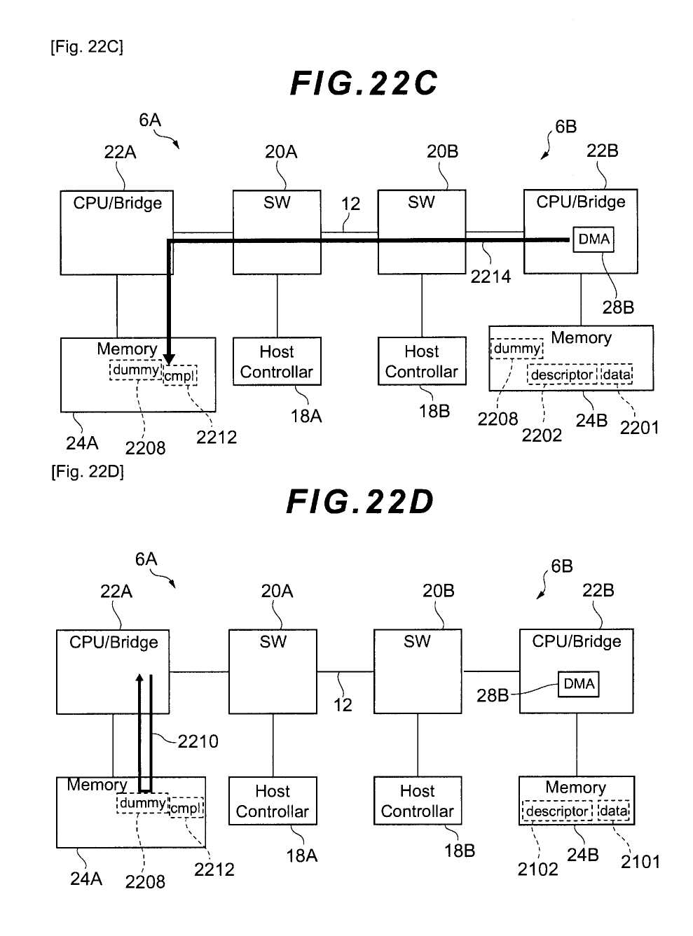

### REFERENCE SIGNS LIST

2A, 2B host computer
6A, 6B cluster
10 storage apparatus
12 connection path between clusters
14A, 14B microprocessor (MP or CPU)
20A, 20B switch circuit (PCI Express switch)
22A bridge circuit
24A, 24B local memory
26A, 26B NTB port
28A, 28B DMA controller

1. A storage apparatus comprising a controller for controlling input and output of data to and from a storage device based on a command from a host computer in which the controller includes a plurality of clusters;
wherein the plurality of clusters respectively include:
an interface with the host computer;
an interface with the storage device;
a local memory;
a connection circuit for connecting to another other cluster; and
a processing apparatus for processing data transfer to and from the other cluster;
wherein, when a first cluster among the plurality of clusters requires a data transfer from a second cluster, the first cluster writes a data transfer request in the local memory of the second cluster, and the second cluster refers to the data transfer request written into the local memory, reads target data of the data transfer request from the local memory, and writes the target data that was read into the local memory of the first cluster 6A.

2. The storage apparatus according to claim 1,
wherein each of the plurality of clusters includes a DMA controller;
wherein the first cluster writes, as the data transfer request, a transfer list of data to be transferred to a DMA controller of the second cluster into the local memory of the second cluster;
wherein the DMA controller of the second cluster refers to the transfer list and writes the target data into the first cluster;
wherein the connection circuit includes a PCI Express switch with an NTB port, and the NTB ports of two clusters are connected via a PCI Express bus;
wherein the DMA controller of the second cluster transfers the target data to the local memory of the first cluster, and thereafter writes completion of the data transfer into the local memory;
wherein the first cluster writes a startup request for starting up the DMA controller of the second cluster into the second cluster;
wherein, after the DMA controller is started up based on the startup request, the DMA controller writes the target data into the local memory of the first cluster according to the transfer list;
wherein each of the plurality of clusters includes a table in the local memory of a self-cluster prescribing a status of the DMA controller of the other cluster;
wherein the self-cluster receives a write request from the other cluster for writing into the table;
wherein the self-cluster refers to the table and writes the transfer list for transferring data to the DMA controller of the other cluster into the local memory of the other cluster; and
wherein the other cluster writes the status of the DMA controller into the table.

3. The storage apparatus according to claim 1,
wherein each of the plurality of clusters includes a DMA controller;
wherein the first cluster writes, as the data transfer request, a transfer list of data to be transferred to a DMA controller of the second cluster into the local memory of the second cluster; and
wherein the DMA controller of the second cluster refers to the transfer list and writes the target data into the first cluster;

4. The storage apparatus according to claim 1,
wherein the connection circuit includes a PCI Express port, and the ports of two clusters are connected with a PCI Express bus.

5. The storage apparatus according to claim 1,
wherein the connection circuit includes a PCI Express switch with an NTB port, and the NTB ports of two clusters are connected with a PCI Express bus.

6. The storage apparatus according to claim 3,
wherein the first cluster writes a startup request for starting up the DMA controller of the second cluster into the second cluster; and
wherein, after the DMA controller is started up based on the startup request, the DMA controller writes the target data into the local memory of the first cluster according to the transfer list;

7. The storage apparatus according to claim 3,
wherein the connection circuit includes a PCI Express switch with an NTB port, and the NTB ports of two clusters are connected via a PCI Express bus; and
wherein the DMA controller of the second cluster transfers the target data to the local memory of the first cluster, and thereafter writes completion of the data transfer into the local memory.

8. The storage apparatus according to claim 3,
wherein an execution entity for executing the data transfer using the processing apparatus is defined in a plurality in each of the plurality of clusters;
wherein each of the plurality of clusters includes the DMA controller in a plurality;
wherein the plurality of execution entities and the plurality of DMA controllers are allocated at a ratio of 1:1, and the execution entity possesses an access right against the allocated DMA controller; and
wherein the execution entity of the second cluster is allocated to the DMA controller of the first cluster.

9. The storage apparatus according to claim 1,
wherein the processing apparatus requests, to a DMA of a cluster to which that processing apparatus belongs, data transfer in the cluster and data transfer to and from the other cluster; and
wherein, if there are a plurality of data transfer requests for transferring data to the DMA controller of a self-cluster, each of the plurality of clusters sets a priority control table defining which requestor's request should be given priority in the DMA controller of the self-cluster and the other cluster, and stores this in the local memory of the self-cluster.

10. The storage apparatus according to claim 3, wherein each of the plurality of clusters includes a table in the local memory of a self-cluster prescribing a status of the DMA controller of the other cluster;
wherein the self-cluster receives a write request from the other cluster for writing into the table; and
wherein the self-cluster refers to the table and writes the transfer list for transferring data to the DMA controller of the other cluster into the local memory of the other cluster.

11. The storage apparatus according to claim 10,
wherein the other cluster writes the status of the DMA controller into the table.

12. A data transfer control method of a storage apparatus comprising a controller for controlling input and output of data to and from a storage device based on a command from a host computer in which the controller includes a plurality of clusters, comprising:
a step of writing a command for transferring data from a first cluster to a second cluster; and
a step of the second cluster writing data that was requested from the first cluster based on the command into the first cluster;
wherein the first cluster transfers, in real time, target data subject to the command from the second cluster to the first cluster without issuing a read request to the second cluster.

13. The data transfer control method according to claim 12,
wherein the data transfer is executed by way of directory memory access via a PCI Express switch connecting the first cluster and the second cluster.
